(19) United States
(12) Patent Application Publication
(10) Pub. No.: US 2009/0063373 A1
(43) Pub. Date: Mar. 5, 2009

(54) METHODS AND APPARATUS FOR ADVERSARIAL REASONING

(76) Inventors: Michael D. Howard, Malibu, CA (US); Eric Huang, Los Angeles, CA (US); Kenneth Y. Leung, CULVER CITY, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/198,437

(22) Filed: Aug. 26, 2008

Related U.S. Application Data
(60) Provisional application No. 60/968,987, filed on Aug. 30, 2007.

(51) Int. Cl. G06N 3/12; G06F 17/00

(52) U.S. Cl. 706/11; 706/13

(57) ABSTRACT

Method and apparatus for an adversarial planner to create a first plan for a first agent and a second plan for a second agent, wherein the first and second plans are independent, identify conflicts between the first and second plans, and address the identified conflicts by planning a contingency branch for one of the agents that resolves the conflict in the agent's favor, and splicing that new branch into the agent's plan.

### CROSS REFERENCE TO RELATED APPLICATIONS

The present application claims the benefit of U.S. Provisional Patent Application No. 60/968,987, filed on Aug. 30, 2007, which is incorporated herein by reference.

### SUMMARY

The present invention provides methods and apparatus for a planner having adversarial reasoning. Exemplary embodiments of the invention provide an efficient way to generate plan iterations after identifying and resolving conflicts. While invention embodiments are shown and described in conjunction with illustrative examples, planner types, and implementations, it is understood that the invention is applicable to planners in general in which it is desirable to generate multiagent plans.

In one aspect of the invention, a method for generating a plan using adversarial reasoning comprises creating a first plan for a first agent and a second plan for a second agent, wherein the first and second plans are independent, identifying a conflict between the first and second plans, replanning to address the identified conflict by planning a contingency branch for the first plan that resolves the conflict in favor of the first agent, splicing the contingency branch into the first plan, and outputting the first plan in a format to enable a user to see the first plan using a user interface.

### BRIEF DESCRIPTION OF THE DRAWINGS

The foregoing features of this invention, as well as the invention itself, may be more fully understood from the following description of the drawings in which:

FIG. 1 is a schematic representation of an adversarial reasoning planning system;

FIG. 2 is a schematic representation of first and second plans;

FIG. 3 is a schematic representation showing a splice of the first plan;

FIG. 4 is a schematic representation showing a plan conflict;

FIG. 5 is a textual representation of an exemplary domain and problem file;

FIG. 6 is a schematic representation of an exemplary contingency plan;

FIG. 7 is a pictorial representation of an exemplary user interface showing contingency plans;

FIG. 8 is a pictorial representation of an exemplary user interface showing a new contingency branch spliced in; and

FIG. 9 is a flow diagram showing an exemplary sequence of steps for adversarial reasoning planning.

### DETAILED DESCRIPTION

In general, the present invention provides methods and apparatus for an adversarial reasoning system, RAPSODI (Rapid Adversarial Planning with Strategic Opponent-Driven Intelligence). In an exemplary embodiment, the RAPSODI system includes a multi-agent reasoning module and a fast single agent planner module. The multi-agent reasoning module refines and expands plans for two or more adversaries by making calls to a planning service provided by the fast single agent planner. In one embodiment, the RAPSODI system employs an iterative plan critic process that results in a contingency plan for each agent, based on a best model of-their capabilities, assets, and intents. The process iterates as many times as the user wants and as long as conflicts can be found. With each iteration agents get “smarter” in the sense that their plans are expanded to handle more possible conflicts with other agents.

Before describing the invention in detail, some introductory material is provided. Adversarial reasoning is a subset of multi-agent reasoning, but agents in adversarial problems are generally not just self-interested, they are actively hostile. Adversarial reasoning aims to predict what the enemy is likely to do and then use that prediction to decide the best ways an agent can achieve its own objectives, which may include subverting the enemy's goals. Ideally, an adversarial planner should be able to suggest not only confrontational, lethal options, but also ways to avoid confrontation and to mislead the enemy.

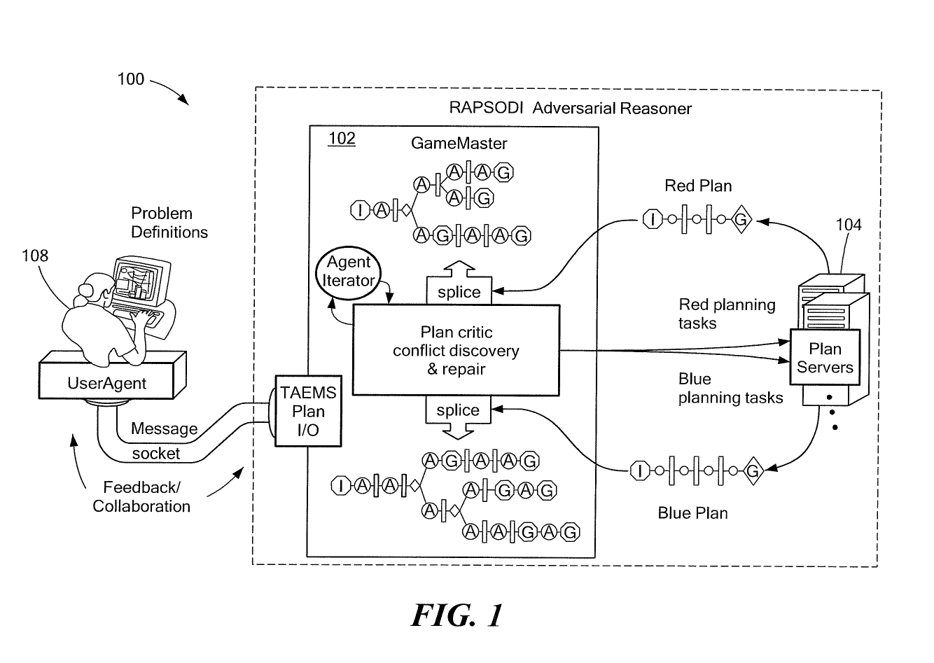

FIG. 1 shows an exemplary adversarial reasoning system in accordance with exemplary embodiments of the invention, which is referred to as RAPSODI (Rapid Adversarial Planning with Strategic Opponent-Driven Intelligence). The system 100 includes a multi-agent plan-critic reasoner 102 referred to as the gamemaster module and a fast single agent planner 104.

The gamemaster module 102 refines and expands plans for two or more adversaries by constructing single-agent planning subproblems and sending them to the fast single-agent planner 104. This single-agent planner 104 provides a plan service that can be located on a different machine in the network. Also the gamemaster module 102 may connect to more than one instance of the planner at a time in order to process different parts of a problem in parallel.

Exemplary embodiments of the inventive system approach adversarial reasoning as a competition between the plans of two or more opponents, where the plans for adversaries are based on a best model of their capabilities, assets, and intents. The gamemaster module 102 embodies an iterative plan critic process that finds specific conflicts between the plans and adds contingency branches to repair the conflicts in favor of one of the agents. The system 100 can iterate as long as the user wants and for as long as conflicts are found. With each iteration, the agents get “smarter” in the sense that their plans are expanded to handle more possible conflicts with other agents. The iteratively improving “anytime” nature of this design is ideal for a decision support application in which users direct and focus the search.

While the inventive RAPSODI system is described in conjunction with the gamemaster reasoner and the single agent planner as deterministic: actions have deterministic effects, and agents know the state of the world without making observations, it is understood that the inventive system is not limited to deterministic embodiments. Although a probabilistic planner may be a better match to the real world, the computational intractability of that type of planner led us to explore a deterministic approach. Deterministic planning for a single agent is already PSPACE-complete, exponential in the number of propositions and actions, and for multiple agents it goes up by another factor. Probabilistic planning, even in the simplest case of single-agent planning with full observability, is undecidable at worst. For example, stochastic games, which extend Markov Decision Processes to multiple agents, is undecidable. The complexity of these approaches increases with the size of the state space and the length of the time horizon. Tractable approaches to probabilistic planning do exist, but they must compromise by using strategies to reduce the search space and limit the time horizon.

Early Artificial Intelligence approaches to adversarial planning, known as game theory, dealt with deterministic, turn-taking, two-player, zero-sum games of perfect information. The minimax algorithm generates the entire search space before nodes can be evaluated, which is not practical in most real-world problems. Since then, game-theory algorithms have developed to prune the search and relax the assumptions in various ways. The inventive plan critic algorithm could be viewed as a relaxation of most of the assumptions of minimax.

The known Course of Action Development and Evaluation Tool (CADET) employs a simple Action-Reaction-Counteraction (ARC) procedure during plan creation. As each action is added to a friendly plan, a likely enemy reaction is looked up from a knowledge base, then a friendly counteraction is added. This is the current state of the art. ARC is a good way to deal with the complexity of adversarial planning, but a simple action reaction lookup does not necessarily produce a strategic response to the best estimates of the enemy's goals and intent.

Texas A&M's Anticipatory Planning Support System (APSS) iteratively expands actions in a friendly plan by searching for enemy reactions and friendly counteractions, using an agent-based approach. Agents select actions to expand based on some importance criteria, and use a genetic simulator to generate different options at the most promising branches along the frontier of the search. A meta-process prevents the combinatorial search from exhausting computing resources.

Referring again to FIG. 1, the RAPSODI system 100 includes a multiagent reasoner 102 and one or more single-agent planners 104. The gamemaster module 102 adversarial reasoner extracts single-agent planning tasks and queries the HAP single-agent planner 104. HAP is a heuristic, iterative improvement, local search planner. The HAP planner itself is not unique; any fast single-agent planner that can implement the inventive plan service API could be used. The Plan Service API is a set of command and response messages used by the gamemaster module 102 to send planning tasks to the planner and get back responses. A planning task is specified using an initial problem definition such as the inventive APDDL (Adversarial Planning Domain Description Language) language, for example, described below. Once the problem domain is defined, the gamemaster module 102 can specify subproblems in the domain and get back very fast responses from the planner.

Consider a problem with two agents: RED and BLUE. In general, our implementation handles any number of agents, with any mix of collaborative or adversarial intents. The problem is very simple in order to illustrate some features of our approach. RED is a land combat unit of two squads having as a goal to gain control of (“clear”) a building. BLUE is an opposing land combat unit of two platoons that has the same goal. Initially, BLUE knows that two RED squads are in the area, but has not yet considered the possibility that they might want to enter the building as well.

Some details of our Adversarial Planning Domain Description Language (APDDL), and excerpts of the input files used to specify this problem are given below. For now it is sufficient to point out that actions are defined in terms of required pre-conditions, and post-action effects, and APDDL includes agent-specific considerations.

An example is now presented illustrating general stages of the plan-critic algorithm. The process begins when the gamemaster module 102 tasks the planner to build a complete plan for each adversary. This means that a commander 108 doing course-of-action planning has specified the goals, capabilities, and intent of each the opposing forces (RED and BLUE in this case) in the input files, which the system will use to plan. The gamemaster module 102 formulates the single-agent planning tasks using applicable parts of the adversarial problem specification. This algorithm builds a model of each agent's behavior incrementally by searching for conflicts and integrating their resolutions, a process that approaches min-max in the limit.

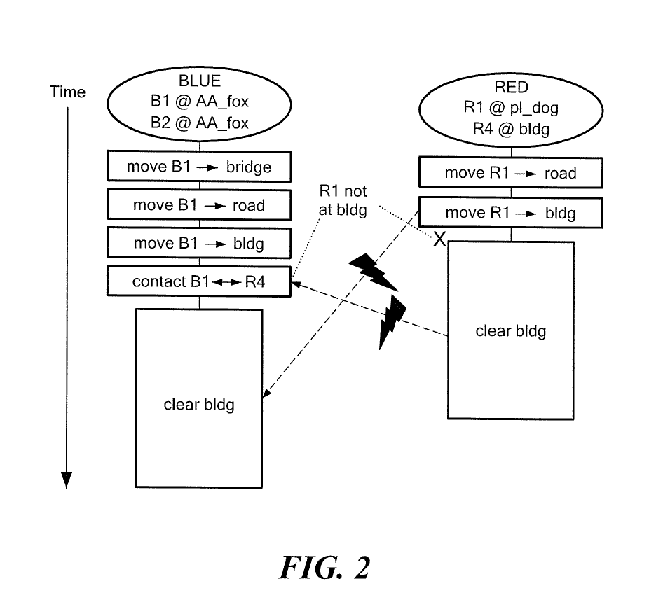

Once an initial plan is made for each agent, the gamemaster module 102 begins the plan-critic iteration process illustrated in FIGS. 2-4. In these figures, the plan for each agent begins at a state represented by the circles at the top of the figure. Actions are represented by boxes, linked together in a temporal sequence from top to bottom, and are labeled by the name of the action. Note that in general, the successive links between the actions do not imply that one action must end before another, and nor do they imply that any series of actions cannot be performed simultaneously. Conflicts are indicated by a dashed arrow between one agent's action and another agent's action. Contingency branches are represented as diamonds in the figures. At such nodes, a set of facts serves as the criterion for the user to determine which branch the agent should take, depending on their values.

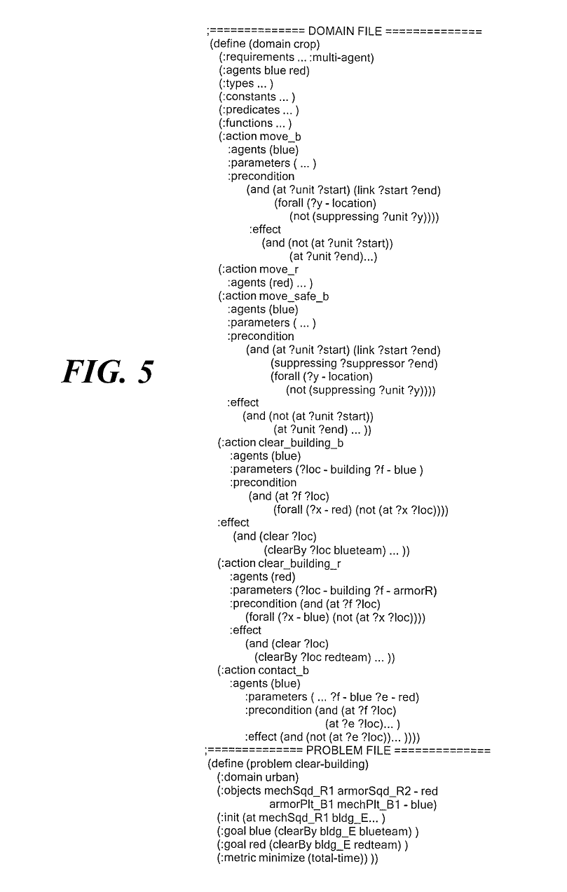

In FIG. 2, the planner has produced a plan for agent BLUE and agent RED to achieve the goals of FIG. 5. Both agents have a goal to gain control of the same building. From BLUE's point of view, RED's clear-bldg action conflicts with BLUE's contact action. We call such a conflict between actions “subversion” (see Definition 1 below). These actions are found to conflict because BLUE's contact action has a precondition that BLUE be in the building, which conflicts with the RED precondition that no BLUEs be present. The gamemaster module 102 then searches a causal chain of the preconditions of RED's clear-bldg action, and has discovered at least one fact that, if changed by a specific time, will resolve the conflict. Note that if the unit R1 were not at the building, there would be no conflict.

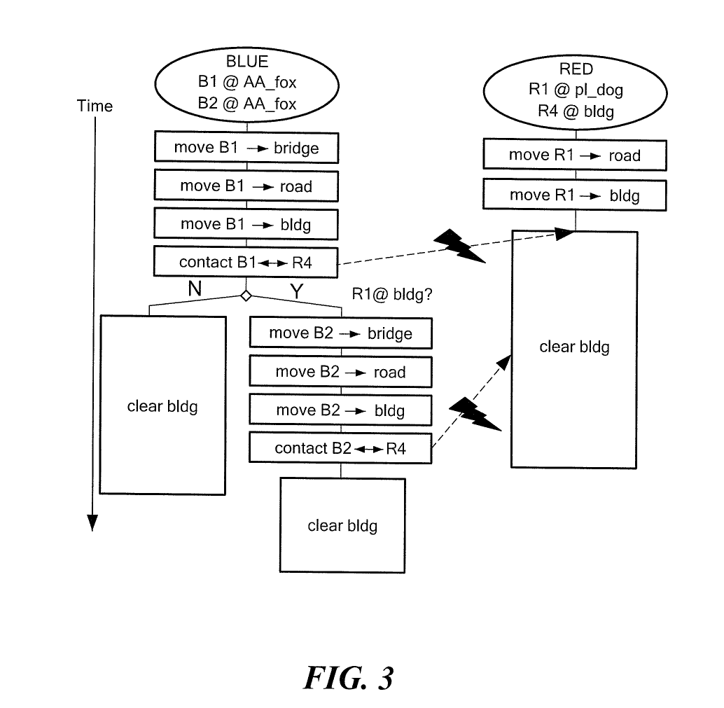

In FIG. 3, BLUE has constructed a partial plan to remove R1 from the building. In this case, because of a restriction we put on BLUE, the partial plan that resolves the conflict brings up another platoon, B2, to attack RED's R1 squad. This partial plan resolution is spliced into BLUE's plan at a new “decision node”, which acts like an IF statement in a declarative programming language. Now the BLUE iteration is complete, and it is RED's turn to find a conflict.

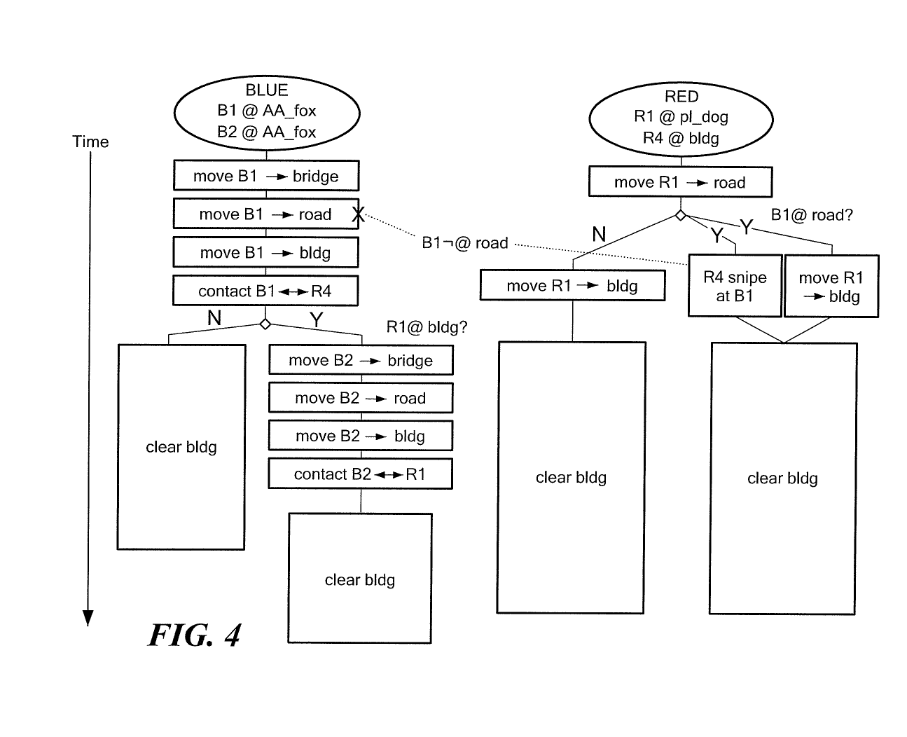

In FIG. 4, RED has detected that when BLUE's B1 platoon moves into the building, it conflicts with the preconditions of its clear-bldg action. It discovers it can resolve the conflict by attacking BLUE in one of several locations. We show it employing a snipe action from the building. As each agent takes a turn looking for conflicts and planning resolutions, it becomes smarter, anticipating more possible conflicts and planning ways to address them. Since the procedure can be halted after each round, it has an anytime aspect: the more time allowed, the more comprehensive the plans.

Because of the iterative human-in-the-loop nature of our inventive processing, it offers the user a chance to monitor its progress and to influence its operation at each iteration. This is desirable in many situations where it is desired that the system act as a decision-support system for a user, and can act like an automated war-gaming assistant, as discussed in further detail below.

Pseudo-code for this iterative-refinement plan-critic adversarial reasoning algorithm used in the gamemaster module is set forth below

step( plans)
Inputs: plans of each player;
Output: Adds a new branch to player's contingent plan.
1. foreach p ∈ players do
2. conf_list ← generateConflicts(plans; p);
3. if size(conf_list) > 0 do
4. conflict ← pickConflict(conf_list);
5. res_list ← generateResolutions(conflict);
6. if size(res_list) > 0 do
7. resolution ← pickResolution(res_list);
8. {partial_plan, splice_point}← resolve(conflict;
resolution; p);
9. splice(partial plan, splice point, p);
10. endif
11. endif
12. endforeach

The above algorithm for adversarial reasoning finds conflicts between player's plan and every other agent's plan, finds a way to resolve one of the conflicts, and splices the resolution into the player's plan as a contingency branch. In summary, each agent takes the following steps:
Lines 2-4. Finding a conflict
Lines 5-7. Finding a resolution to the chosen conflict
Line 8. Replanning to achieve both the original goals as well as the new resolution goals
Line 9. Splicing the newly created plan into the contingency plan
   We will now consider each of the steps above in turn.

Step 1: Finding a Conflict

As mentioned above, a conflict means an action in one plan interferes with an action in another plan. The planning community has a similar concept for conflicts within a singleagent plan, called mutual exclusions (MUTEX is a common abbreviation). A difference between our concept of a conflict and that described as a mutex include the fact that conflicts are anti-symmetric.

Definition 1. Subversion: Given an action a1 scheduled to be performed during some time interval [t11; t12] and an action a2 scheduled for the interval [t21; t22], then there is a conflict between a1 and a2 if the following conditions hold:
The time intervals overlap, e.g.: t11≦t22≦t12 or t21≦t12≦t22
The effects negate the other action's preconditions: if t11≦t22≦t12, then this condition is satisfied if a2 has an effect that removes support for a precondition of al. The reverse case is true if the actions overlap in the other way.

In the example above a2 subverts al. Note that we assume that the preconditions for an action must hold throughout the duration of the action, and that the effects of an action are applied only at the end of the action. This is less expressive at characterizing real world problems than the full PDDL language allows, but for our purpose is a simplifying assumption that can be made in suitable situations.

Pseudocode for an exemplary generateConflicts method is given below:

generateConflicts(plans; player)
Inputs: A set of non-branching plans, one for each agent, and the name of
the agent for which we are finding conflicts.
Output: A set of action pairs {(a1; b1)...(an; bn)}| player's action a(i) is in
conflict with another agent's action b(i).
1. stateHistory ← initial state;
2. forall p ∈ plans do
3. startQ ← rootAction(p)
4. endforall
5. while (a ← getNextAction( )) ≠ null and conflicts= Ø; do
6. if a is from player's plan then
7. forall (b ∈ endQ) | b subverts a do
8. conflicts ← (a; b)
9. endforall
10. conflicts ← (a, subverters(a))
11. if conflicts = Ø; then
12. (serial_sim, endQ) ← a
13. endif
14. else
15. if stateHistory supports a and
(∀ b ∈ endQ) b does not subvert a) then
16. (serial_sim, endQ) ← a
17. endif
18. endif
19. endwhile
20. while endQ ≠ Ø ; do
21. serial_sim ← endQ
22. endwhile
23. return conflicts

StartQ and endQ are priority queues of actions, sorted by the earliest start time and end time, respectively. StartQ is additionally sorted in priority of the player name passed in to the method, in whose favor conflicts are to be resolved. Actions are selected for processing from the start queue, and moving them to the endQ schedules them for execution. Either pop(queue) or action←queue removes the action at the top of the list. Conflicts are discovered by checking for the conflict conditions mentioned above between actions in the chosen player's plan against opponent actions.

The procedure is to simulate forward the plans of each player, starting from the root, recording every conflict between a single Course Of Action (COA) from each player's plan. A COA is a single path through a contingency plan, choosing a branch at each decision node. It starts by initializing the simulation with the initial conditions, applying the earliest action by each player, and then sequentially updating the world by interleaving actions in temporal order. Actions scheduled to execute from time [t0; t1] are allowed to successfully execute if and only if their preconditions hold in the interval [t0; t1). This is called the “serial simulation” (serial_sim in the pseudocode), because the algorithm effectively serializes the actions from among all agents(i.e., merges into a single temporally ordered list), and simulates which actions would fail due to subversion and which actions would successfully be applied to the state.

In line 10, subverters of an action are found by analyzing stateHistory to find actions that deleted required preconditions of the action. In line 15, stateHistory supports an action if all the action's preconditions are true in the state. Later, in getNextAction line 6 or 11, when an action is applied to stateHistory, the action's effects are made true in the state. Note that after the first conflict is found (e.g., another player's action deletes the add effect of the priority player's action), the state of that fact is uncertain. Therefore the method returns when the first conflicted action in player's plan is found (line 5 exits the while loop). Multiple conflicts may be returned for that player's action because it may conflict with more than one other players.

Exemplary pseudo code for getNextAction is set forth below:

```
getNextAction( )
Inputs: Read/write access to startQ and endQ.
Output: The next action to be processed. startQ and endQ are updated as
side effects.
1. while startQ ≠Ø ; do
3.  node ← startQ
2.  if node is an action then
3.  endQ← node
4.  startQ ←successor(node)
5.  while endQ ≠Ø and endTime(top(endQ)) ≦ endtime(node)
          do
6.  apply pop(endQ) to stateHistory
7.  endwhile
8.  return (node)
9. else node is a decision node
10.  while endQ ≠Ø and endTime(top(endQ)) ≦ endTime(node)
          do
11.  apply pop(endQ) to stateHistory
12.  endwhile
13.  startQ ← successor(pop(startQ)))
14.  endif
15. endwhile
```

The routine getNextAction, called in line 5 of generateConflicts, returns the next action in time from each player's plan. The same two priority queues, startQ and endQ, are used in both methods. GetNextAction replaces the top node on the startQ with its successor, and puts the node into the endQ where it can be processed according to end time. In lines 5 and 10 the endQ is not necessarily emptied. Actions are removed and applied only as long as their end times are not later than the node just pulled off the startQ. If node is a decision node, the method returns the next action after that.

Step 2: Finding a Resolution to the Chosen Conflict

A resolution is a fact and associated time that would resolve the chosen conflict if the value of the fact could be changed by the specified time. There are several types of resolutions for a conflict:
1. Subvert a precondition of the conflicting action, before that conflicting action occurs
2. Subvert an action that supports a precondition of the conflicting action. (This can be done recursively up the tree)
3. Subvert an action by making the opponent prefer a different course of action

The exemplary method generateResolutions generates these three types of resolutions. A specific resolution will be chosen for inclusion with the original set of goals. The choice may be made by asking the user to make a choice, or a decision engine can make the choice, based on some metrics. Resolution type 1 is straightforward (see lines 1-3 of generateResolutions below). Each precondition of the conflicting action is negated and added individually to the list of candidate resolutions. This means that if we can make any one of the preconditions false, the action cannot be performed, and hence cannot lead to a conflict.

Type 2 is a generalization of Type 1 (see generateResolution, lines 4-11) and requires the information resulting from our serial simulation. The basic idea is that a chain of actions—each one providing support for the next—which eventually leads to the conflict. Interrupting this chain by negating the precondition of any action in the chain at the appropriate time would effectively prevent the conflict from arising later on. Hence, the serial simulation list is processed backwards to find the action that most recently supported each fact that we want to subvert. Then we find the actions that supported each of those facts, and put negations of their preconditions on the resolution list. Of course, this process can be repeated all the way back to the initial conditions, although we only show one step for clarity.

Type 3 resolution causes the opponent to choose a different branch on its contingentPlan tree so that the action on the current branch of the tree will not be taken (generateResolution, lines 12-25). Each decision node (dNode) in the opponent's plan is inspected. A decision node is equivalent to a chain of if-then-else-if statements. Each if-condition is a set of propositions (or their negations) whose conjunction must be true in order for that particular branch to be taken. A default case is one with no conditions, and is taken if none of the other cases are true. The strategy is to manipulate the state so that the opponent would branch differently in his contingent plan upon arrival at a decision point in his plan whereby avoiding the path that leads to the observed conflict. In military situations, this is akin to operations like “channelizing the enemy” where we cause the enemy to move in a way that is easier for us to prepare for. This is done by falsifying the condition that would cause the conflicting branch to be taken (the branch of the opponent's contingentPlan that contains the action that is in conflict with ours), and at the same time, to make one of the other branch conditions true. Due to our assumptions about the iterative method of building the opponent model, any alternative branch behavior to the current one would necessarily reduce the opponent model to a previously solved problem. The choice of which other branch is actually made true may be left up to the user or to a decision engine. The gamemaster module is only compiling the user's options into the contingentPlan.

An exemplary pseudo code for generateResolutions for generating resolutions to a chosen conflict is set forth below:

generateResolutions(conflict)
Inputs: Conflict to be resolved (a conflict identifies action ca in an
adversary's ContingentPlan that conflicts with one of ours).
Output: An array of resolution goals (each resolution goal being a set
of grounded facts, and a resolution time) that would resolve the given
conflict if made true.
1. forall f ∈ preconditions of ca do
2. add resolution( [symbol] f, start time(ca));
3. endforall
4. serial sim← time-sorted actions in all other agents' plans
5. forall f ∈ preconditions of ca do
6. forall a ∈ serial sim that support f| end(a)<start(ca) do
7. forall f2 ∈ preconditions of a do
8. add resolution( [symbol] f2,start time(a));
9. endforall
10. endforall
11. endforall
12. dNode ←previous_decision_node(ca);
13. while not done
14. branch ← branch of contingentPlan containing ca;
15. if branch = default of(dNode) then
16. forall k ∈ branches(dNode)-branch do
17. add resolution(condition(k),start(dNode));
18. endforall
19. endif
20. elseif branch ≠ default_of(dNode) then
21. forall f ∈ branch condition(branch) do
22. add resolution( [symbol] f,start(dNode));
23. endforall
24. endelseif
25. dNode ← previous_decision_node(dNode);
26. if dNode == root then done endif;
27. endwhile

Step 3. Planning to Achieve the Resolution

By now we have found ways of resolving the conflict, and have chosen which resolution we want to implement. A resolution is just a fact that we want to negate, which will prevent the generation of a conflict. By “planning to achieve the resolution” we mean finding a plan that not only achieves our original goals, but also makes a particular fact true or false by a time deadline. The resulting plan must be spliced into the current plan no later than a time deadline that must be met to satisfy the resolution, less the makespan of the plan. We search for a partial plan iteratively, moving backward in time from the required resolution time, until we can construct a successful partial plan. Each time the planner is tasked to add the original goals plus the new resolution goal, and replan from an initial state that is a step earlier in the existing plan (an earlier action from serial sim in line 2). In addition, we constrain the planner to react to enemy actions in the serial simulation by asserting them as constraints whose form will be explained below. The process proceeds like the pseudocode for resolve(conflict, resolution) below. Note that in step 5 we are planning with the world state after a as the initial state, and the resolution added to the goals.

Exemplary pseudo code for resolve(conflict, resolution) for generating a plan to achieve the chosen resolution is set forth below:

resolve(conflict; resolution)
Inputs: A conflict and a resolution fact that, if made false, will resolve the
conflict.
Output: A plan that achieves the resolution goals, and a time at which it
should be spliced into the contingentPlan.
1. serial sim←merge actions in agents' plans, sorting by time
2. forall a ∈ actions in serial sim | end(a)<end(conflict) do
3. if a ∈ my plan then continue endif;
4. constraints ← effects of opp actions after end(a) in TILs
5. partial plan← plan(stateAt(end(a)), resolution; constraints);
6. if (partial plan ≠{Ø}) then
7. return(partial plan, end time(a));
8. endif
9. endforall

Note that this procedure returns the first plan with which we can achieve the resolution successfully; e.g., we move backward in time looking for the first point at which we can implement the resolution and subvert the conflicting action. There is an argument for looking for the latest splice point, and it may be worth mentioning here. First, the later the splice point, the more the “element of surprise” is capitalized upon which gives the opponent less time to find alternative means to generate that same conflict. Second, the further back we place the splice point, the less accurate the current state is of predicting the opponent's intent to cause the conflict. However, in some circumstances it may be desirable to keep searching for splice points earlier in the plan to find the best place to branch. For example, a required resource may be more available at an earlier time.

The constraints are asserted to the planner in the form of “Timed Initial Literals” (TILs). As is known in the art, TILs were developed for the 2004 International Planning Competition as a way to express “a certain restricted form of exogenous events: facts that will become TRUE or FALSE at time points that are known to the planner in advance, independently of the actions that the planner chooses to execute. Timed initial literals are thus deterministic unconditional exogenous events.” Planners that are capable of processing TILs turn them into preconditions that, when active, may disallow some actions and enable others. We use them to describe the appearance and activities of an adversary at certain times and places. The consequence of using this mechanism for asserting our constraints is that the TILs are just a projection of the opponent model and simply play back a pre-determined script of propositions being asserted and negated. Therefore the single-player planning agent is not allowed to interact with these propositions, but only allowed to plan around the events. In fact, in order to allow actions to change these events, it is necessary to encode the opponent model into the planner itself. In such a case we wouldn't be able to simply substitute in any single-agent planner in the system.

Step 4. Splicing the Resolution into the ContingencyPlan

The splice method is given a plan that achieves the resolution, and a time when it should be spliced into our plan. The main purpose of splice is to figure out how to set up the decision node that will become the splice point. Again, a serial simulation is created by adding all the actions in all plans to one list, and sorting them by start time. We calculate a conjunctive set of facts that are preconditions of any opponent action that can create the conflict, and that will become the test condition in the decision node. This is done by iterating backward on the serial simulation to find the fact preconditions of the actions whose effects support the conflict fact. In general, the properties of the state that this method recommends to examine may be an inaccurate indicator of the opponent's intent to cause a particular conflict. The inaccuracy increases when there are multiple ways an opponent might cause such a conflict, in which the predictor for a single method of causing the conflict would fail.

Another issue is to figure out the splice point in the current player's Contingent-Plan. This is not obvious, because typically we are given an insertion point from the serial simulation that is just before the adversary's action that we want to subvert, and we need to translate that into a corresponding point in the current player's plan (i.e the node in the current player's plan that occurs immediately before the splice point in the serial simulation). This is implemented by traversing backward in the serial simulation to the first action that our agent owns that occurs after the insertion point. Then we traverse backward from this node in-our ContingentPlan to the first node whose parent starts prior to the other player's action. This node is the splice point, or “effectiveSP”.

The partial plan is spliced into the current player's contingent-Plan by adding a decision node linked to the partial plan. If the effectiveSP points to a pre-existing decision node, we just add a case to that node. Otherwise, we add a new decision node.

Exemplary pseudo code for splicing in a plan is set forth below:

```
splice(PP, SP)
Input: A partial plan PP implementing a resolution, and a splice point SP
giving a time at which to  splice PP into our contingentPlan
output: A contingentPlan for current agent with the partial plan spliced in.
1. serial_sim ← merge actions in all agents' plans before my conflicting
action, sorting
2.  by time
3.  // Calculate a conjunctive set of facts that are preconditions of
      any opponent
4.  // action that can create the conflict.
5. branching_mask ← getRequiredFacts (SP, serial_sim)
6.
7. if (SP.agent == curAgent)then
8.  effectiveSP ← SP
9. else // splice point node is in adversary's contingent plan
10. // find the node in our plan that occurs most recently after SP
11. effectiveSP ← findSplicePointInCurAgent(SP);
12. endif
13. // Splice the PartialPlan into the tree
14. If (SP.startTime==effectiveSP.startTime && (effectiveSP is a
DecisionNode) )
15.  add a new case to the decisionNode using (list(actions in PP),
      branchMask)
16.  link PP to effectivePP decision node
17.else
18.  newDN ← a new decision node with case (list (actions in PP),
      branchingMask)
19.  link newDN between parent (effectiveSP) and child(effectiveSP)
20. endif
21. return
```

Adversarial problems are asserted to RAPSODI in our variant of the Planning Domain Description Language, PDDL 2.2, developed for the International Planning Competitions. PDDL describes actions in terms of a predicate-logic language of precondition facts that must obtain must be satisfied for the action to fire, and effect facts that will become true when the action is applied. Durative actions can be specified, and the PDDL spec also includes quantification in preconditions.

Our Adversarial PDDL (APDDL) adds to PDDL 2.2 features to describe multiple agents with private knowledge and individual goals. An excerpt of the APDDL problem description files used to specify the problem discussed above is given in FIG. 5. APDDL includes agent-specific considerations. It adds :multi-agent to the :requirements line, and an :agents line after that to define all the agents in the domain. Each action has an :agents line that lists specific agents that have permission to run the action. Also, in the problem file the goals for each agent are declared separately.

The RAPSODI system keeps track of the sets of actions that each agent can perform and each agent's goal that must achieved. It is possible to feed each agent a separate set of facts to plan with. This is the place to feed in beliefs that each agent may hold. Note that a fact that is not referenced in the preconditions of an action is in effect a private fact. Since APDDL provides a way to specify which agents can perform which actions, a private belief is implemented by ensuring that only actions owned by a certain agent can read or write that fact.

The top-level gamemaster process shown above asks in each iteration which conflict to resolve (step 4) and which of a number of possible resolutions is most desirable to attempt (step 7). In these decisions a user applies heuristics and experience that cannot be captured in our simple problem definition format. For now, we leave this up to the user, regarding it as a positive way for the user to interact with the planning process and influence its decisions while the computer works out the details. So during each iteration of the algorithm, the user is given a choice of conflicts and resolutions for each player. However, this approach means that the planner must describe the conflicts and resolutions in a meaningful way, which is actually more difficult than having the planner make the choices. One would like to describe a conflict in a way that includes the cost of ignoring it versus the cost of dealing with it.

For example, the problem specified in FIG. 5 results in the following initial plans for each agent:

Initial ContingentPlan for Player ’blue’:
[0,2] (move_b armorplt_b1 aa_fox bridge)
[2,4] (move_b armorplt_b1 bridge road_e)
[4,6] (move_b armorplt_b1 road_e bldg_e)
[6,11] (contact_b bldg_e armorplt_b1 mechsqd_r4)
[11,31] (clear_building_b bldg_e armorplt_b1)
Initial ContingentPlan for Player ’red’:
[0,2] (move_r armorsqd_r1 road_e pl_dog)
[2,4] (move_r armorsqd_r1 pl_dog bldg_e)
[4,24] (clear_building_r bldg_e armorsqd_r1)

The start and end times of each action are listed on the left. BLUE is moving unit armorsqd b1 to the objective, bldg e, where a RED unit is expected. It performs a contact operation to neutralize the Red, and then a clear building action. Red's plan is to move another unit into the building and then clear the building, putting it under RED control. When we ask for conflicts from BLUE's perspective, the presence of the extra red unit in the building is flagged because it violates a constraint that one contact action only neutralizes one enemy. The system displays the conflict in terms of the two conflicting actions:

Searching for conflicts for Player ’blue’.
Please choose a conflict to work on:
==> Conflict 1
Player #0 action @ time 6.0 - 11.0:
contact_b bldg_e armorplt_b1 mechsqd_r4
Player #1 action @ time 4.0 - 24.0:
clear_building_r bldg_e armorsqd_r1
Enter conflict choice [integer]: 1

The conflict is chosen, and 5 resolutions are found. Each is a fact that, if made true, will resolve the conflict in favor of player BLUE:

Searching for resolutions for Player ’blue’:
Please choose one of the following resolutions:
==>Resolution 1, Time 24.0, Fact #185:
’not at armorsqd_r1 bldg_e’
==>Resolution 2, Time 24.0, Fact #1:
’at armorplt_b1 bldg_e’
==>Resolution 3, Time 24.0, Fact #9:
’at mechplt_b2 bldg_e’
==>Resolution 4, Time 4.0, Fact #186:
’not at armorsqd_r1 road_e’
Enter resolution choice [integer]: 1

The planner is tasked to find a partial plan that can implement the chosen resolution. The resolution is to bring up another BLUE platoon to attack the RED squad in a contact action. Then gamemaster merges the resolution into contingent plan. In this process it must find a partial plan that can be implemented in time, so there is an additional check for a starting time from which the resolution can be planned. Finally, the partial plan can be spliced into the main contingency plan at a decision node that contains a masking conditional that is used to decide which way to branch:

```
Trying an initial start time of 11 to satisfy a
resolution goal time of 22. Searching... The
maximum number of steps were taken, but no plan was
found. Trying an initial start time of 6 to satisfy
a resolution goal time of 22. Searching...
PartialPlan has initial start time of 6:
[0,5] (contact_b bldg_e armorplt_b1 armorsqd_r1)
[0,2] (move_b mechplt_b2 aa_fox bridge)
[2,4] (move_b mechplt_b2 bridge road_e)
[4,6] (move_b mechplt_b2 road_e bldg_e)
[6,11] (contact_b bldg_e mechplt_b2 mechsqd_r4)
[11,31] (clear_building_b bldg_e armorplt_b1)
Agent blue's plan:
[0,2] move_b armorplt_b1 aa_fox bridge
[2,4] move_b armorplt_b1 bridge road_e
[4,6] move_b armorplt_b1 road_e bldg_e
[6,6]
IF(at armorsqd_r1 bldg_e
    not at armorplt_b1 bldg_e
    not at mechplt_b2 bldg_e)
    [6,11] contact_b bldg_e armorplt_b1 armorsqd_r1
    [6,8] move_b mechplt_b2 aa_fox bridge
    [8,10] move_b mechplt_b2 bridge road_e
    [10,12] move_b mechplt_b2 road_e bldg_e
    [12,17] contact_b bldg_e mechplt_b2 mechsqd_r4
    [17,37] clear_building_b bldg_e armorplt_b1
ELSE
    [6,11] contact_b bldg_e armorplt_b1 mechsqd_r4
    [11,31] clear_building_b bldg_e armorplt_b1
Agent red's plan:
[0,2] (move_r armorsqd_r1 road_e pl_dog)
[2,4] (move_r armorsqd_r1 pl_dog bldg_e)
[4,24] (clear_building_r bldg_e armorsqd_r1)
... process ended before asking for RED conflicts.
```

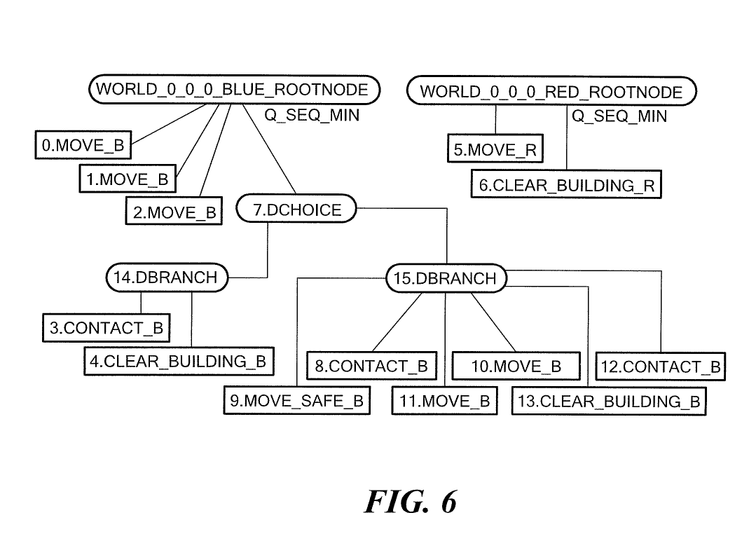

FIG. 6 shows contingency plans for Blue and Red in TAEMS format. 7.DCHOICE is a decision node with two branches, where 15.DBRANCH was planned by Blue to handle the conflict with Red's plan. Gamemaster sends the plan in TAEMS string form on a messaging socket to a decision support agent that helps the user review and interact with the plans. The planner saves a copy of each plan it generates, so if the user has questions on one of them or wants to make a change, gamemaster can formulate a command referencing the plan.

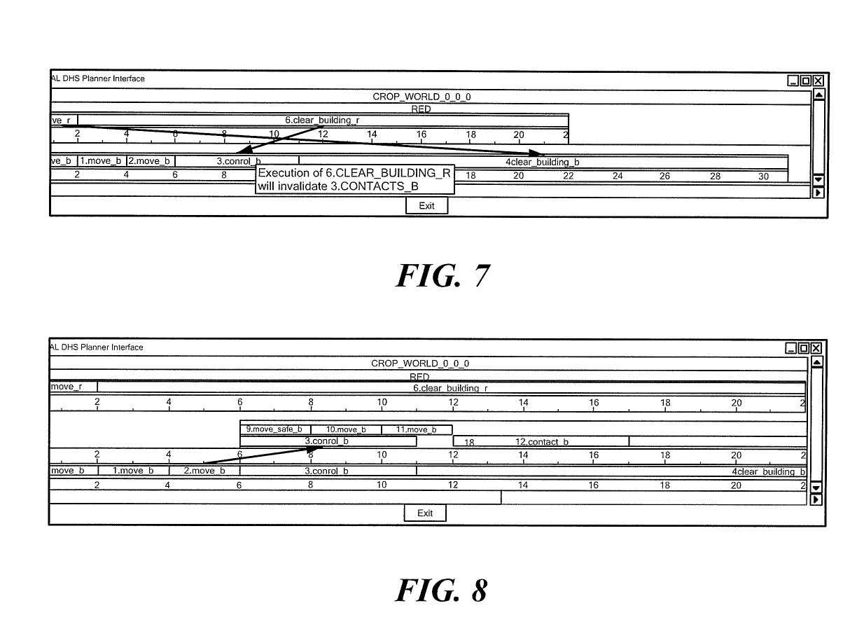

FIG. 7 shows one of our attempts to show conflicts to the user on the RAPSODI system. The horizontal panels separated by thin lines show a contingency plan for RED above a contingency plan for BLUE. Actions in each plan are displayed in a bar above a time-line, with short action names in white along the bar. More detail is provided in “tool tips” to reduce screen clutter. In this figure, we have generated conflicts against the BLUE player. An arrow between two actions indicates that the action at the beginning of the arrow conflicts with the action at the arrowhead. FIG. 8 shows the resolution for this conflict spliced into BLUE's plan.

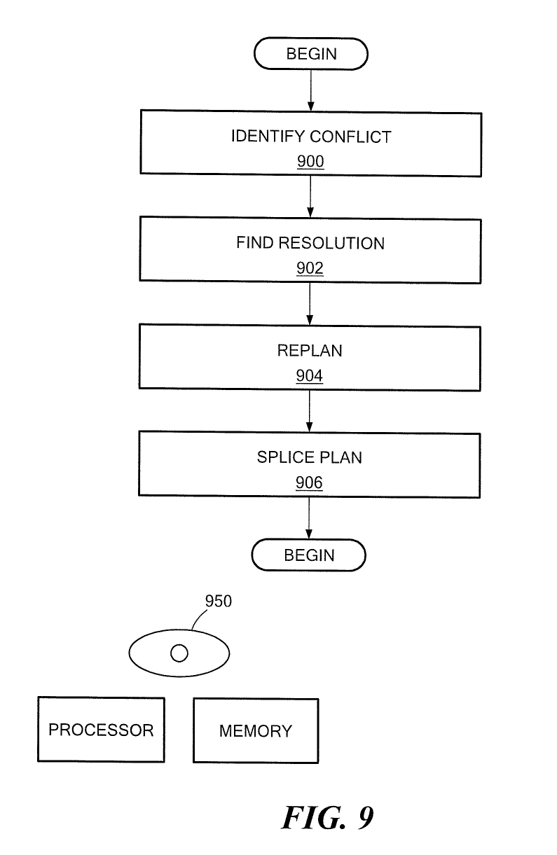

FIG. 9 shows an exemplary sequence of steps for implementing adversarial planning in accordance with exemplary embodiments of the invention. In step 900, the planner identifies a conflict between first and second plans, such as controlling the same building in FIG. 2. In step 902, a resolution is found, where a resolution is a fact and associated time that resolves the identified conflict. Exemplary types of resolution include subverting a precondition of the conflicting action, before that conflicting action occurs, subverting an action that supports a precondition of the conflicting action, and subverting an action by making the opponent prefer a different course of action. In step 904, replanning is performed to implement the resolution to achieve the original goal and make a given fact true or false by a given time. In step 906, the plan is spliced to achieve the resolution.

The present invention provides methods and apparatus for an iterative plan-critic technique for adversarial reasoning that has been implemented in an automated planning system, RAPSODI (Rapid Adversarial Planning with Strategic Operational Decision Intelligence). The main process, gamemaster, can connect to one or more planning services at a time over a socket. The single-agent planning could in theory be replaced by any planner that can implement the planner API.

It is understood that exemplary methods and apparatus of the invention may take the form, at least partially, of program code (i.e., instructions) embodied in tangible media 950 (FIG. 9), such as floppy diskettes, CD-ROMs, hard drives, random access or read only-memory, or any other machine-readable storage medium, including transmission medium. When the program code is loaded into and executed by a machine, such as a computer, the machine becomes an apparatus for practicing the invention. Exemplary embodiments may be embodied in the form of program code that is transmitted over some transmission medium, such as over electrical lo wiring or cabling, through fiber optics, or via any other form of transmission. Exemplary embodiments may be implemented such that herein, when the program code is received and loaded into and executed by a machine, such as a computer, the machine becomes an apparatus for practicing the invention. When implemented on a general-purpose processor(s), the program code combines with the processor to provide a unique apparatus that operates analogously to specific logic circuits.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An iterative method for generating a plan using adversarial reasoning, comprising:
creating a first plan for a first agent and a second plan for a second agent, wherein the first and second plans are independent;
identifying conflicts between the first and second plans;
replanning to address one of the identified conflicts by planning a contingency branch for the first plan that resolves the conflict in favor of the first agent;
splicing the contingency branch into the first plan; and
outputting the first plan in a format to enable a user to see the first plan using a user interface.

2. The method according to claim 1, wherein the conflict includes a first action of the first plan and a second action of the second plan having overlapping time intervals wherein the effects of the first action negates preconditions for the second action.

3. The method according to claim 2, further including providing the conflicts to a user and receiving input from the user including a user selection of a conflict to be resolved next.

4. The method according to claim 2, further including applying a metric to importance rank a plurality of conflicts and selecting the most important conflict to be resolved next.

5. The method according to claim 1, wherein the step of replanning includes iteratively moving backward in time from just before the conflict and searching for a conflict resolution plan until one or more successful resolutions are found.

6. The method according to claim 5, further including outputting successful conflict resolution plans to a user and receiving a user selection of one of the conflict resolution plans to splice into the contingency plan.

7. The method according to claim 5, further including applying a metric to rank conflict resolution plans for selecting a resolution plan to splice into the contingency plan.

8. The method according to claim 1, wherein the step of splicing includes creating at a splice point a decision node that records assertions about the world that, if true, identifies a new branch as the most successful plan.

9. An article, comprising:
a storage medium comprising computer-readable instructions that enable a machine to iteratively generate a plan using adversarial reasoning by:
creating a first plan for a first agent and a second plan for a second agent, wherein the first and second plans are independent;
identifying a conflict between the first and second plans;
replanning to address the identified conflict by planning a contingency branch for the first plan that resolves the conflict in favor of the first agent;
splicing the contingency branch into the first plan; and
outputting the first plan in a format to enable a user to see the first plan using a user interface.

10. The article according to claim 9, wherein the conflict includes a first action of the first plan and a second action of the second plan having overlapping time intervals wherein the effects of the first action negates preconditions for the second action.

11. The article according to claim 10, further including instructions for providing the conflict to a user and receiving input from the user including a user selection of a conflict to be resolved next.

12. The article according to claim 10, further including instructions for applying a metric to importance rank a plurality of conflicts to enable selection of a conflict to be resolved next.

13. The article according to claim 9, wherein the step of replanning includes iteratively moving backward in time from just before the conflict and searching for a conflict resolution plan until a successful one is found.

14. The article according to claim 9, further including instructions for outputting successful conflict resolution plans to a user and receiving a user selection of one of the conflict resolution plans to splice into the contingency plan.

15. The article according to claim 9, further including instructions for applying a metric to rank conflict resolution plans for selecting a resolution plan to splice into the contingency plan.

16. The article according to claim 9, wherein the step of splicing includes creating at a splice point a decision node that records assertions about the world that, if true, identifies a new branch as the most successful plan.

17. A planner system, comprising:
a processor;
a memory coupled to the processor; and
a module for execution by the processor to create a first plan for a first agent and a second plan for a second agent, wherein the first and second plans are independent, identify a conflict between the first and second plans, replan to address the identified conflict by planning a contingency branch for the first plan that resolves the conflict in favor of the first agent, splice the contingency branch into the first plan, and output the first plan in a format to enable a user to see the first plan using a user interface.
